(19) United States
(12) Patent Application Publication
(10) Pub. No.: US 2019/0066147 A1
(43) Pub. Date: Feb. 28, 2019

(54) COMPUTER IMPLEMENTED METHOD AND A COMPUTER SYSTEM FOR DELIVERING ONE OR MORE INCENTIVES FROM ONE OR MORE MERCHANT DEVICES TO A CLIENT DEVICE

(71) Applicant: MASTERCARD INTERNATIONAL INCORPORATED, Purchase, NY (US)

(72) Inventors: Navneet Jain, Pune (IN); Sonal Vishwas Khanvilkar, Pune (IN); Arunmurthy Gurunathan, Pune (IN)

(21) Appl. No.: 16/053,944

(22) Filed: Aug. 3, 2018

(30) Foreign Application Priority Data
Aug. 25, 2017 (SG) 10201706964X

(51) Int. Cl. G06Q 30/02; H04W 4/80

(52) U.S. Cl. CPC G06Q 30/0238; H04W 4/80; G06Q 30/0224; G06Q 30/0237

(57) ABSTRACT

A computer implemented method for delivering one or more incentives from one or more merchant devices to a client device, the client device being associated with a user, the computer implemented method comprising determining proximity between the client device and the one or more merchant devices, the proximity being determined based on a distance between the client device and the one or more merchant devices being within a predetermined threshold, querying, based on such determination, a loyalty database to identify an association status between the client device and the one or more merchant devices and providing the one or more incentives to the client device based on the association status.

### CROSS-REFERENCE TO RELATED APPLICATION

This application claims the benefit of and priority to Singapore Patent Application No. 10201706964X filed Aug. 25, 2017. The entire disclosure of the above application is incorporated herein by reference.

### FIELD

The present disclosure generally relates to payment transactions between a merchant and a user and, in particular embodiments, to a computer system and a computer implemented method for delivering one or more incentives from one or more merchant devices to a client device.

### BACKGROUND

This section provides background information related to the present disclosure which is not necessarily prior art.

A user may use a number of ways to make payments to a merchant for goods and/or services purchased from the merchant. Additional incentives, such as loyalty points, special offers and discounts, may be provided to the user by the merchant for attracting the user for subsequent visits. Generally, these incentives are provided through a multitude of channels, such as SMS, e-mail, loyalty point credits in an account and in different forms, such as membership cards, physical coupons and coupon codes, etc. However, for the user, it becomes tedious to manage and keep track all these incentives, let alone use them.

The problem is aggravated if the user has not already been provided with the incentives. The user in that case may need to search for offers and discounts for the goods and services of interest. This may range from browsing the internet, downloading special mobile applications, finding newspaper and magazine cuttings and physically enquiring at a merchant location. In addition to all of the above, there is no standard method for redemption of the incentives, especially if the incentives are of more than one type. In such a case, tedious calculations may need to be performed by the merchant or the user to arrive at an actual transaction amount.

In light of the discussion above, there is a need for a computer system and a computer implemented method for processing a transaction between a merchant and a user which alleviates one or more of the above mentioned deficiencies.

Any discussion of the background art throughout the specification should in no way be considered as an admission that such background art is prior art nor that such background art is widely known or forms part of the common general knowledge.

### SUMMARY

This section provides a general summary of the disclosure, and is not a comprehensive disclosure of its full scope or all of its features. Aspects and embodiments of the disclosure are set out in the accompanying claims.

According to a first aspect of the present disclosure, there is provided a computer implemented method for delivering one or more incentives from one or more merchant devices to a client device, the client device being associated with a user, the computer implemented method comprising determining proximity between the client device and the one or more merchant devices, the proximity being determined based on a distance between the client device and the one or more merchant devices being within a predetermined threshold, querying, based on such determination, a loyalty database to identify an association status between the client device and the one or more merchant devices and providing the one or more incentives to the client device based on the association status.

According to a second aspect of the present disclosure, there is provided a computer system for delivering one or more incentives from one or more merchant devices to a client device associated with a user, the computer system being in communication with the one or more merchant devices and the client device over a communication network, the computer system comprising a memory unit configured to store machine readable instructions, a processor operably connected with the memory device, the processor obtaining the machine-readable instructions from the memory device, and being configured by the machine-readable instructions to determine proximity between the client device and the one or more merchant devices, the proximity being determined based on a distance between the client device and the one or more merchant devices being within a predetermined threshold, query, based on such determination, a loyalty database to identify an association status between the client device and the one or more merchant devices and provide the one or more incentives to the client device based on the association status.

According to a third aspect of the present disclosure, there is provided a non-transitory computer readable medium, having stored thereon, machine readable instructions for delivering one or more incentives from one or more merchant devices to a client device, the client device being associated with a user, the machine readable instructions when executed by a processor, configure the processor to determine proximity between the client device and one or more merchant devices, the proximity with reference to the client device being within a predetermined distance from the one or more merchant devices, query, based on such determination, a loyalty database to identify an association status between the client device and the one or more merchant devices and provide the one or more incentives to the client device based on the association status.

As used in this document, the term “payment card” refers to any suitable cashless payment device, which can either be associated with a payment account or can be a stored-value payment device. Thus the term includes physical cards, such as a credit card, a debit card, a prepaid card and a charge card. The physical payment card may carry payment account information, for example, it may comprise a Primary Account Number (PAN) of a payment card. Alternatively, the payment card may be implemented in a software in an electronic device, such as a user's mobile communication device (e.g., smartphone or tablet computer). For example, the payment card may be an app or a service running on the communication device which allows the user to make a payment or a digital wallet service, using an associated payment account.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. With that said, embodiments will be described with reference to the accompanying drawings, in which:

FIG. 1 illustrates an exemplary environment of computing devices in which or with which the various embodiments described herein may be implemented;

FIG. 2 illustrates a computer implemented method for delivering one or more incentives from one or more merchant devices to a client device, in accordance with an embodiment;

FIG. 3 illustrates an information flow diagram involving receiving of respective geographical locations of a client device and one or more merchant devices at a computer system, in accordance with an embodiment;

FIG. 4 illustrates determination of a geographical location of the client device using four or more beacons, in accordance with an embodiment;

FIG. 5 illustrates determination of the geographical location of the client device using four or more cellular towers, in accordance with an embodiment;

FIG. 6 illustrates identification of an association status between the client device and the one or more merchant devices, in accordance with an embodiment; and

FIG. 7 illustrates provision of a plurality of payment options at a Point of Sale (POS) terminal and the client device.

It should be noted that the same numeral represents the same or similar elements throughout the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure.

Throughout this specification, unless the context requires otherwise, the words “comprise”, “comprises” and “comprising” will be understood to imply the inclusion of a stated step or element or group of steps or elements but not the exclusion of any other step or element or group of steps or elements.

Any one of the terms: “including” or “which includes” or “that includes” as used herein is also an open term that also means including at least the elements/features that follow the term, but not excluding others.

It is typical nowadays for a user to be holding a number of payment card variants associated with a payment card service. The payment card service, which may be Mastercard®, Visa®, or American Express®, for example, may act as an intermediary between merchants, the merchants' bank(s) and the users' bank(s) in order to authorize, clear and settle transactions made with payment cards compatible with the payment card service. Also, it is typical for a merchant to offer membership cards to the users of these payment cards. A membership card may carry with it, inter alia, reward points, a certain membership account number that may be associated or “tagged” with a particular payment card number in a loyalty database. The loyalty database may be maintained by any one of the merchant, the payment card service or any other third party service appointed by one or more of the merchant and the payment card services. Moreover, the tagging may be done at the merchant's end or by the user himself/herself using a wallet application, wherein the user may manually enter or scan the payment card and the membership card to tag them together.

It is contemplated here that a computer system, such as a merchant server, or a payment card server or a third party server, determines proximity between a client device associated with the user and one or more merchant devices associated with respective one or more merchants. In other words, the computer system determines if the client device is within a predetermined threshold of the one or more merchant devices. Such a determination may be initiated by a wallet application (“pull” scenario or by the computer system itself “push” scenario). If that is true, the computer system receives a payment card number from the client device (such as through the wallet application). Further, the computer system queries the loyalty database using the payment card number and identifies if there exists a membership account number that links both the one or more merchants and the payment card numbers. Based on such a relationship, incentives may be awarded to the user at the client device. Once the user visits a merchant outlet to make a purchase, the incentives may be combined with a net purchase amount to generate a number of payment options.

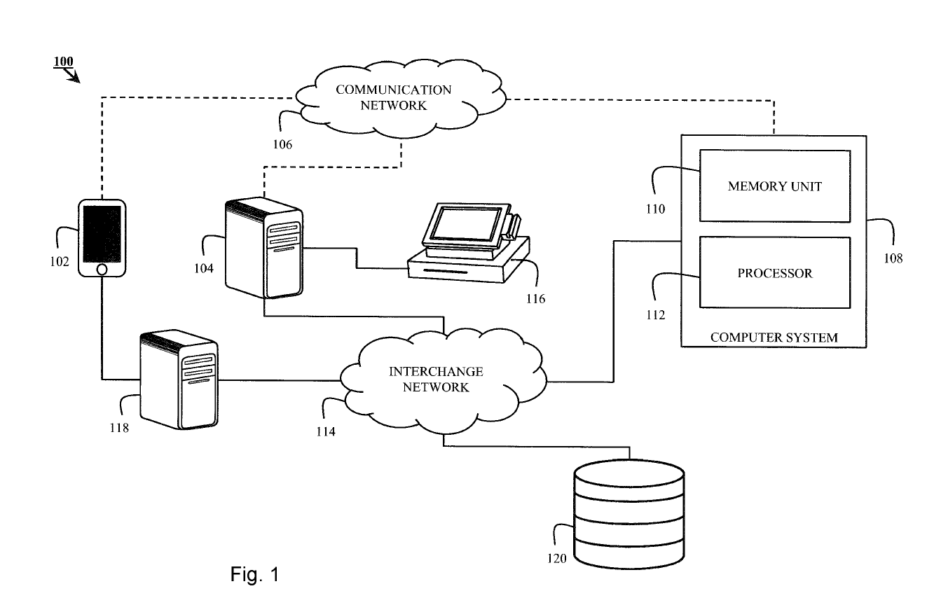

FIG. 1 illustrates an exemplary environment 100 of computing devices to which the various embodiments described herein may be implemented. As shown in FIG. 1, the environment 100 comprises a client device 102 associated with a user. In various embodiments, the client device 102 is selected from a group consisting of mobile handheld devices, such as cellular phones, PDAs and tablet PCs, etc. The client device 102 is connected with a communication network 106. The communication network 106 may be implemented through one or more of a plurality of protocols, such as, but not limited to, Ethernet, Wi-Fi, Bluetooth, ZigBee, GSM and CDMA etc. Further, the communication network 106 may be a Local Area Network (LAN) or a Wide Area Network (WAN). Further connected to the communication network 106 are one or more merchant devices 104 associated with one or more respective merchants. The one or more merchant devices 104 may embody one or more database servers or storage devices or online data stores having incentives in the form of discount coupons, early access to products, loyalty points, reward points and other such promotion campaigns which have not been assigned to any particular customer yet.

Also connected with the communication network 106 is a computer system 108. The computer system 108 here may embody a merchant server associated with the one or more merchants, a payment server associated with the payment card service or a third party server associated with a third party responsible for delivering the incentives and appointed by one or more of the merchants and the payment card service. It is further envisaged here that the computer system 108 has computing capabilities, including, but not limiting to, a memory unit 110 and a processor 112 operably connected with the memory unit 110. The memory unit 110 may be a non-volatile memory unit, such as, but not limited to, EPROM, EEPROM and Flash Memory. The processor 112 may be, for example, a general purpose processor, an Application Specific Integrated Circuit (ASIC) or a Field Programmable Gate Array (FPGA), etc. The memory unit 110 is configured to store machine readable instructions. The machine readable instructions may be loaded into the memory unit 110 from a non-transitory computer readable medium. The computer system 108 is further connected with an interchange network 114.

In various embodiments, the interchange network 114 is an Internet based network configured to exchange transaction data between a plurality of gateway servers, associated with a plurality of respective banks and a plurality of payment servers associated with the payment card service. The interchange network 114 may necessitate that the communications between the plurality of gateway servers and the plurality of payment servers follow standard protocols and be secured using data encryption protocols, such as, but not limited to, SSL or TLS. One example of a standard for exchange of transaction data is ISO 8583: Financial transaction card originated messages—Interchange message specifications. It is envisaged here that the one or more merchant devices 104 are also connected with the interchange network 114 and therefore are able to register payment card transactions carried out through a Point of Sale (POS) terminal 116. It is further envisaged that the client device 102 has capabilities of connecting to the interchange network 114 through a wallet application, and therefore might require mediation of an Application Program Interface (API) server 118. It is further envisaged that a loyalty database 120 is also connected to the interchange network 114. The loyalty database 120 is configured to store:

a. payment card numbers associated with a user; and

b. membership account numbers issued by the one or more merchants.

Various embodiments may now be understood taking the exemplary environment 100 as a reference.

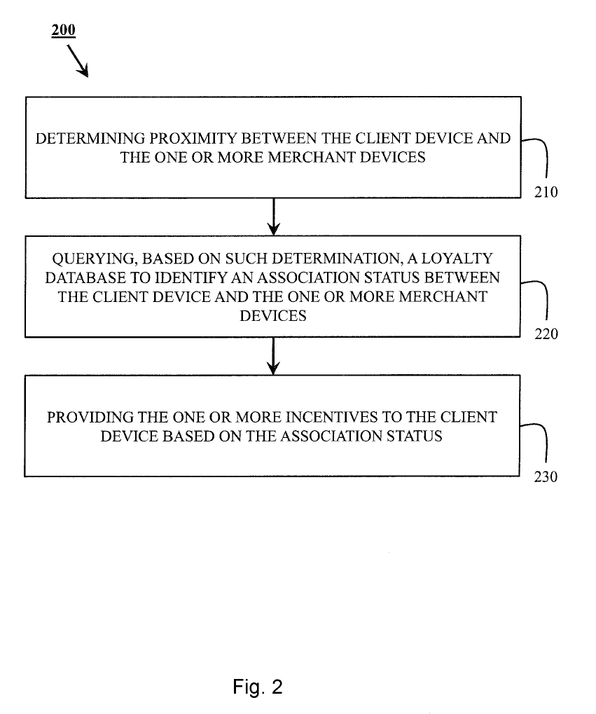

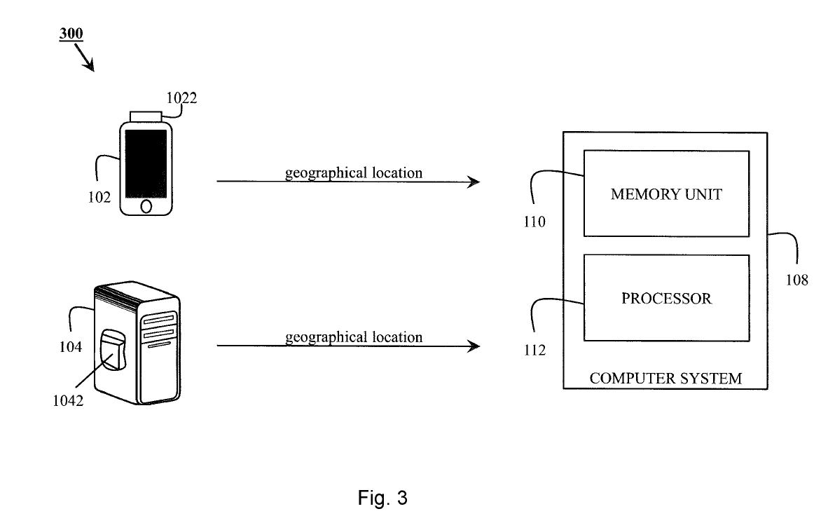

FIG. 2 depicts exemplary steps of a computer implemented method 200 for delivering one or more incentives from the one or more merchant devices 104 to the client device 102 in accordance with certain embodiments. The method 200 begins at a step 210 when the processor 112 determines proximity between the client device 102 and the one or more merchant devices 104. Here, the proximity is determined based on a distance between the client device 102 and the one or more merchant devices 104 being within a predetermined threshold. In one embodiment, as shown in an information flow diagram 300 of FIG. 3, determining the proximity comprises receiving, over the communication network, a geographical location of the client device 102, from the client device 102 and receiving, over the communication network, a geographical location of the one or more merchant devices 104. In that manner it is envisaged that the wallet application has an in built capability to obtain the geographical location of the client device 102 from a Global Positioning System (GPS) device 1022 (or other transceiver capable of communicating with a global navigation satellite system, such as GLONASS, Galileo or BeiDou) installed in the client device 102 and transmit the geographical location to the processor 112. This is a “pull” scenario, where the wallet application broadcasts (for example, periodically on an automatic basis, or on user request) its position and request for incentives from nearby merchant devices. The one or more merchant devices 104 are also envisaged to have capabilities of broadcasting their geographical location to the computer system 108 using another GPS device 1042 or some other equivalent technology.

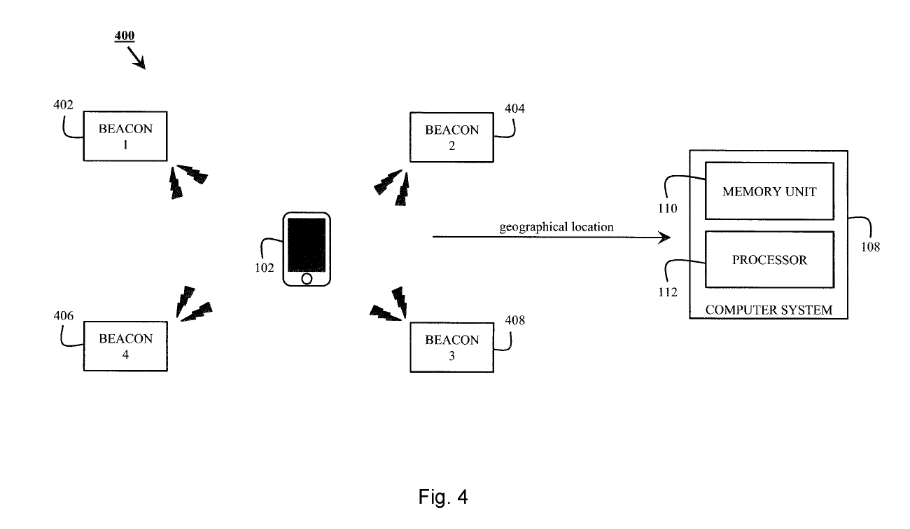

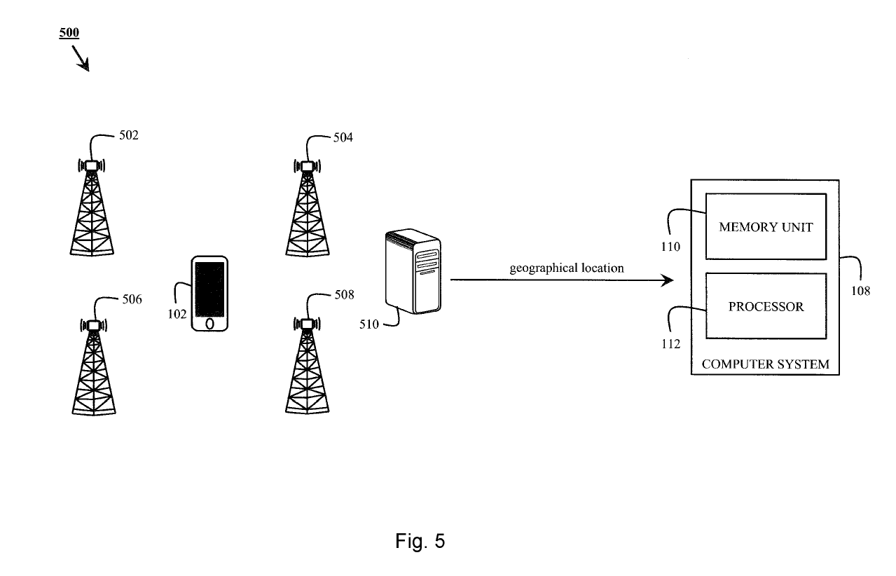

In various other embodiments, the geographical location of the client device 102 is determined using a unique identifier associated with the client device 102. The unique identifier may be pertinent to types of a communication network 106 that the client device 102 is capable of connecting to. Some of the examples of the unique identifier are selected from International Mobile Equipment Identity (IMEI) for GSM phones, Mobile Equipment Identifier (MEID) or Equipment Serial Number (ESN) for CDMA phones, a SIM (Subscriber Identity Module) number, a Personal Identification Number (PIN) for Blackberry™ devices, a Media Access Protocol (MAC) address for Wi-Fi or Bluetooth Networks, a Serial Number, an Android ID for Android™ Devices and a Unique Device Identifier (UDID) for iOS™ devices. In that manner, it is envisaged that in case of a MAC address the geographical location of the client device 102 may be determined using four or more beacons 402, 404, 406 and 408 as shown in an illustration 400 of FIG. 4. Similarly, in case of an IMEI number, the geographical location may be determined by a telecommunication server 510 operating a GSM network using four or more cellular towers 502, 504, 506 and 508 and such geographical location may be transmitted to the computer system 108 by the telecommunication server 510, as shown in an illustration 500 of FIG. 5. This is a “push” scenario, where the geographical location of the client device 102 is tracked and applicable incentives are pushed to the client device 102, as will be seen in the following steps.

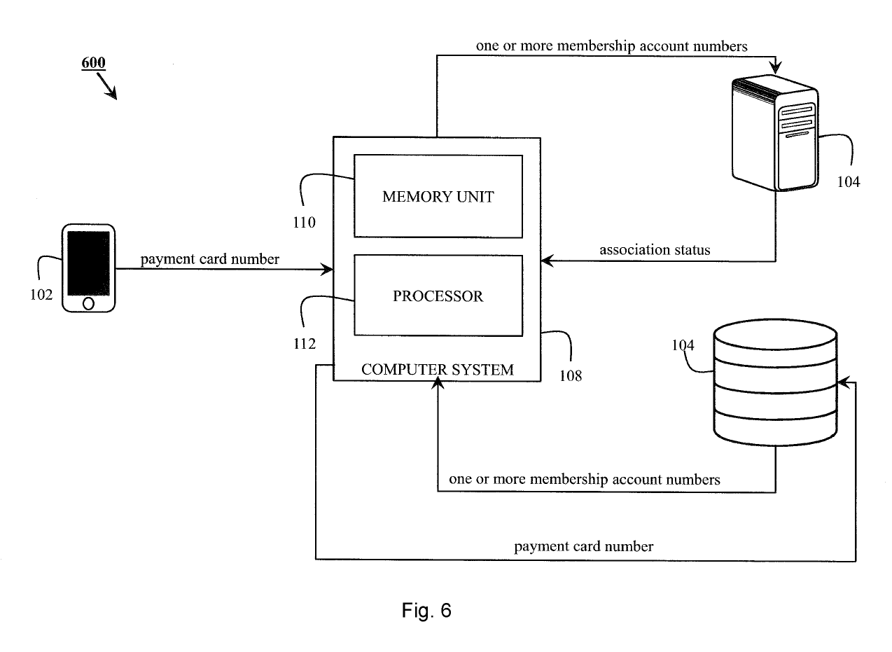

At a step 220, based on such determination, the processor 112, queries the loyalty database 120 to identify an association status between the client device 102 and the one or more merchant devices 104. In one embodiment, the processor 112 receives an authorization from the client device 102 before querying the loyalty database 120. The authorization may be in the form of a “YES” or “NO” prompt in the wallet application. In another embodiment, the authorization may involve clicking of a Uniform Resource Locator (URL) sent through an SMS or an email or an instant message, for example. Further, in some embodiments, the processor 112 receives a payment card number associated with the user, from the client device 102. The payment card number has already been tagged with one or more membership account numbers of the user, wherein the loyalty database 120 comprises the details of the payment card number and the tagged one or more membership account numbers. The processor 112 compares the one or more membership account numbers against the one or more merchant devices 104 and generates the association status. This has been illustrated in an illustration 600 of FIG. 6.

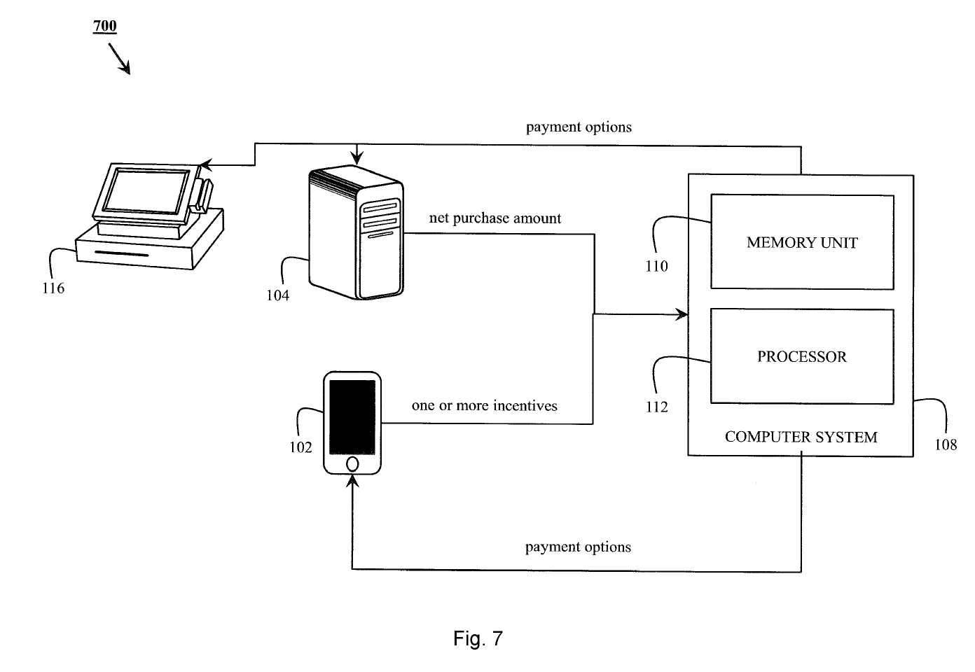

At a step 230, the processor 112 provides the one or more incentives to the client device 102 based on the association status. In some embodiments, the processor 112 receives one or more available incentives from the one or more merchant devices 104. Further, the processor 112 determines the one or more incentives from the one or more available incentives, based on the association status. The user may use the one or more incentives when the user wishes to make a purchase at a merchant outlet. This way after the user has selected certain goods and/or services he/she may provide the one or more incentives back to the computer system 108 through the interchange network 114. The processor 112 receives the one or more incentives from the client device 102 and generates a plurality of payment options as a function of a net purchase amount and the one or more received incentives. For example, one payment option may be part payment by card and part payment by loyalty points, another payment option may be part payment by card and part payment by discount coupon. The processor 112 further provides the plurality of payment options to the at least one of the Point of Sale (POS) terminal 116 and the client device 102, depending upon whether it is an offline purchase or an online purchase, respectively. The same has been illustrated in an illustration 700 of FIG. 7.

The embodiments discussed above offer a number of advantages. All the received incentives, such as membership cards, discount coupons and special offers, etc., may be automatically linked to the payment card number as soon as a user enters within proximity of designated merchants. Further, the incentives can be utilized using either a digital wallet, or a physical payment card, or both, for both online purchases and purchases done at a physical location, respectively. Consequently, the user need not carry all the acquired membership cards, discount coupons, etc., all the time as the same have already been automatically linked to the payment card number. Also multiple payment options may be generated using the received incentives and the net purchase amount allowing the user to make the payment in a number of ways using combinations of various different incentives with the payment card.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g., RAM) and/or non-volatile (e.g., ROM, disk) memory, carrier waves and transmission media. Exemplary carrier waves may take the form of electrical, electromagnetic or optical signals conveying digital data streams along a local network or a publically accessible network, such as the Internet.

It should also be understood that, unless specifically stated otherwise as apparent from the following discussion, it is appreciated that throughout the description, discussions utilizing terms such as “controlling” or “obtaining” or “computing” or “storing” or “receiving” or “determining” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

It should be noted that where the terms “server”, “secure server” or similar terms are used herein, a communication device is described that may be used in a communication system, unless the context otherwise requires, and should not be construed to limit the present disclosure to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the disclosure, it should not be construed to limit the present disclosure to any particular logic flow or logic implementation. The described logic may be partitioned into different logic blocks (e.g., programs, modules, functions, or subroutines) without changing the overall results or otherwise departing from the true scope of the disclosure. Often, logic elements may be added, modified, omitted, performed in a different order, or implemented using different logic constructs (e.g., logic gates, looping primitives, conditional logic, and other logic constructs) without changing the overall results or otherwise departing from the true scope of the disclosure.

The terms and descriptions used herein are set forth by way of illustration only and are not meant as limitations. Examples and limitations disclosed herein are intended to not be limiting in any manner, and modifications may be made without departing from the spirit of the present disclosure. Those skilled in the art will recognize that many variations are possible within the spirit and scope of the disclosure, and their equivalents, in which all terms are to be understood in their broadest possible sense unless otherwise indicated.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings, but is to be providing the broadest scope consistent with the principles and the novel and inventive features disclosed or suggested herein. Accordingly, the disclosure is anticipated to hold on to all other such alternatives, modifications, and variations that fall within the scope of the present disclosure and appended claims.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. And, again, the terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer implemented method for delivering one or more incentives from one or more merchant devices to a client device, the client device being associated with a user, the computer implemented method comprising:
determining proximity between the client device and the one or more merchant devices, the proximity being determined based on a distance between the client device and the one or more merchant devices being within a predetermined threshold;
querying, based on such determination, a loyalty database to identify an association status between the client device and the one or more merchant devices; and
providing the one or more incentives to the client device based on the association status.

2. The computer implemented method of claim 1, further comprising receiving an authorization from the client device, before querying the loyalty database.

3. The computer implemented method of claim 1, wherein determining the proximity comprises:
receiving over a communication network a geographical location of the client device, from the client device; and
receiving over the communication network a geographical location of the one or more merchant devices.

4. The computer implemented method of claim 3, wherein the geographical location of the client device is determined using a unique identifier associated with the client device.

5. The computer implemented method of claim 1, wherein querying the loyalty database comprises:
receiving a payment card number associated with the user, the payment card number being already tagged with one or more membership account numbers of the user, wherein the loyalty database comprises the details of the payment card number and the tagged one or more membership account numbers; and
comparing the one or more membership account numbers against the one or more merchant devices and generating the association status.

6. The computer implemented method of claim 1, further comprising:
generating a plurality of payment options as a function of a net purchase amount and the one or more received incentives; and
providing the plurality of payment options to at least one of a Point of Sale (POS) terminal and the client device.

7. The computer implemented method of claim 1, further comprising:
receiving one or more available incentives from the one or more merchant devices; and
determining the one or more incentives based on the association status.

8. A computer system for delivering one or more incentives from one or more merchant devices to a client device associated with a user, the computer system being in communication with the one or more merchant devices and the client device over a communication network, the computer system comprising:
a memory unit configured to store machine readable instructions;
a processor operably connected with the memory device, the processor obtaining the machine-readable instructions from the memory device, and being configured by the machine-readable instructions to:
determine proximity between the client device and the one or more merchant devices, the proximity being determined based on a distance between the client device and the one or more merchant devices being within a predetermined threshold;
query, based on such determination, a loyalty database to identify an association status between the client device and the one or more merchant devices; and
provide the one or more incentives to the client device based on the association status.

9. The computer system of claim 8, wherein the processor is further configured to receive an authorization from the client device, before querying the loyalty database.

10. The computer system of claim 8, wherein for determining the proximity, the processor is further configured to:
receive, over a communication network, a geographical location of the client device, from the client device; and
receive, over a communication network, a geographical location of the one or more merchant devices.

11. The computer system of claim 10, wherein the processor is further configured to determine the geographical location of the client device using an unique identifier associated with the client device.

12. The computer system of claim 8, wherein for querying the loyalty database the processor is further configured to:
receive a payment card number associated with the user, the payment card number being already tagged with one or more membership account numbers of the user, wherein the loyalty database comprises the details of the payment card number and the tagged one or more membership account numbers; and
compare the one or more membership account numbers against the one or more merchant devices and generating an association status.

13. The computer system of claim 8, wherein the processor is further configured to:
generate a plurality of payment options as a function of a net purchase amount and the one or more received incentives; and
provide the plurality of payment options to at least one of a Point of Sale (POS) terminal and the client device.

14. The computer system of claim 8, wherein the processor is further configured to:
receive one or more available incentives from the one or more merchant devices; and
determine the one or more incentives based on the association status.

15. A non-transitory computer readable medium, having stored thereon, machine readable instructions for delivering one or more incentives from one or more merchant devices to a client device, the client device being associated with a user, the machine readable instructions when executed by a processor, configure the processor to:
determine proximity between the client device and one or more merchant devices, the proximity with reference to the client device being within a predetermined distance from the one or more merchant devices;
query, based on such determination, a loyalty database to identify an association status between the client device and the one or more merchant devices; and
provide the one or more incentives to the client device based on the association status.

16. The non-transitory computer readable medium of claim 15, comprising further instructions to enable the processor to receive an authorization from the client device, before querying the loyalty database.

17. The non-transitory computer readable medium of claim 15, comprising further instructions to enable the processor, while determining the proximity, to:
receive, over a communication network, a geographical location of the client device, from the client device; and
receive, over a communication network, a geographical location of the one or more merchant devices.

18. (canceled)

19. The non-transitory computer readable medium of claim 15, comprising further instructions to enable the processor, while querying the loyalty database, to:
receive a payment card number associated with the user, the payment card number being already tagged with one or more membership account numbers of the user, wherein the loyalty database comprises the details of the payment card number and the tagged one or more membership account numbers; and
compare the one or more membership account numbers against the one or more merchant devices and generating the association status.

20. The non-transitory computer readable medium of claim 15, comprising further instructions to enable the processor to:
generate a plurality of payment options as a function of a net purchase amount and the one or more received incentives; and
provide the plurality of payment options to at least one of a Point of Sale (POS) terminal and the client device.

21. The non-transitory computer readable medium of claim 15, comprising further instructions to enable the processor to:
receive one or more available incentives from the one or more merchant devices; and
determine the one or more incentives based on the association status.
